(19) United States
(12) Patent Application Publication
(10) Pub. No.: US 2003/0071823 A1
(43) Pub. Date: Apr. 17, 2003

(54) Output image adjustment of graphics data

(76) Inventor: Kenji Fukasawa, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/238,127

(22) Filed: Sep. 9, 2002

(30) Foreign Application Priority Data
Sep. 11, 2001 (JP) 2001-275169(P)
Jul. 12, 2002 (JP) 2002-203591(P)

(51) Int. Cl. G09G 5/02

(52) U.S. Cl. 345/589

(57) ABSTRACT

A CPU 200 reads a graphics file GF from a memory card MC and temporarily places the read graphics file GF in RAM 210. CPU 200 acquires graphics processing control information GI from the read out graphics file GF and searches for a WorkSpaceColor tag designating a work color space for graphics processing. If CPU 200 successfully finds a WorkSpaceColor tag it acquires, from the designated work color space information, work color space matrix values and a second gamma correction value which is the gamma correction value for the designated work color space, and executes graphics processing in the designated work color space.

### BACKGROUND OF THE INVENTION

1. Technical Field

The present invention relates to a technique for processing graphics data.

### BACKGROUND ART

In contrast to ordinary photosensitive silver salt color cameras whose typical output mode is printing onto photographic paper, digital still camera (DSC) and digital video camera (DVC) photographs, and digital images input by a scanner, have the advantage that images can be manipulated easily on a personal computer.

However, if graphics processing is not performed properly, some data in the source image may be lost, resulting in degraded quality of graphics data. For example, range adjustment is typically done to improve contrast, but if range adjustment is performed in a color space (color representation system) in which highly saturated colors are represented by negative color values, the negative color values wind up being clipped to zero, so that high saturation information is lost.

Proper graphics processing requires properly setting the work color space for processing of graphics data, but setting work color space properly requires advanced knowledge of graphics processing. Further, designating a desired color space for the work color space requires the user to designate the work color space using advanced retouching software, a tedious process.

Using a work color space that has a wider color representation range than the color space of the source image data is useful in improving saturation, but on the other hand tends to depress tone characteristics; compensating for depressed tone characteristics requires setting parameters that affect image qualities to proper values, and setting parameter values appropriately for graphics data requires a knowledge of graphics processing.

Also, if a wider work color space is simply selected without regard to the reproducible color range of the output device used to output graphics data, it may be impossible to accurately reproduce the colors of the graphics data, so that the advantages of using a wider color space are lost.

The above problems are addressed by the present invention, which has as an object to provide a graphics processing device that enables graphics processing to be accomplished simply, in an appropriate work color space, with reference to particular graphics data. A further object is to provide a graphics data generating device wherein appropriate information relating to work color space may be associated with graphics data.

### SUMMARY OF THE INVENTION

To solve these problems, the invention in a first aspect thereof provides a graphics data generating device. The graphics data generating device pertaining to the first aspect herein comprises a graphics data acquisition unit for acquiring graphics data; a work color space-designating information acquisition unit for acquiring work color space-designating information that designates a work color space for graphics processing in a graphics processing device; and an output unit for outputting said acquired graphics data associated with said work color space-designating information.

According to the graphics data generating device pertaining to the first aspect herein, graphics data can be output in association with work color space-designating information designating a work color space for graphics processing performed by a graphics processing device that will be used to process the graphics data, thereby enabling a work color space appropriate for the graphics data to be designated in the graphics data generating device.

The graphics data generating device pertaining to the first aspect herein may further comprise a color conversion table-designating information generating unit for generating color conversion table-designating information that designates a color conversion table used to generate said output graphics data in an output processing control device that generates output graphics data using said graphics data. With this arrangement, a color conversion table can be designated with reference to a designated work color space, whereby the results of graphics processing obtained by designating work color space can be output more accurately.

The graphics data generating device pertaining to the first aspect herein may further comprise a graphics processing control data generating unit for designating graphics processing conditions in said graphics processing device with reference to said acquired work color space-designating information, wherein said output unit outputs said graphics data associated with said graphics processing control data as well as with said work color space-designating information. With this arrangement, graphics processing conditions for a designated work color space can be designated by the graphics data generating device for a particular graphics processing device, so that graphics processing can be performed appropriately for individual sets of graphics data.

In the graphics data generating device pertaining to the first aspect herein, said work color space may have at least in a portion of the gamut thereof a color representation range wider than the sRGB color space. This enables output with higher saturation levels.

The graphics data generating device pertaining to the first aspect herein may further comprise a graphics data generating unit for generating said graphics data; and a memory unit for storing a multitude of sets of said work color space-designating information; wherein said graphics data acquisition unit acquires said generated graphics data; and said work color space-designating information acquisition unit acquires said work color space-designating information from said memory unit. This allows a work color space for particular graphics data to be selected from among a multitude of sets of work color space-designating information.

In a graphics data generating device pertaining to the first aspect herein, said output unit may output said graphics data and said work color space-designating information as a single graphics file. In this way graphics data and work color space-designating information may be acquired by handling a single graphics file, and the association between the two can be easily preserved.

In a graphics data generating device pertaining to the first aspect herein, said work color space-designating information may designate a color space having a different coordinate system than the color space of said graphics data. Designating a coordinate system appropriate to the color reproduction characteristics of an output device enables high saturation images to be output.

The invention in a second aspect thereof provides a computer-readable medium containing a program for generating graphics data. The computer-readable medium pertaining to the second aspect herein comprises a program command for generating graphics data; a program command for acquiring space-designating information that designates a work color space for graphics processing in a graphics processing device used to process said graphics data; and a program command for outputting said generated graphics data associated with said work color space-designating information.

The computer-readable medium pertaining to the second aspect herein affords working effects similar to the graphics data generating device pertaining to the first aspect herein. Like the graphics data generating device pertaining to the first aspect herein, the computer-readable medium pertaining to the second aspect herein may be reduced to practice in various ways.

The invention in a third aspect thereof provides a graphics processing device. The graphics processing device pertaining to the third aspect herein comprises a graphics data acquisition unit for acquiring graphics data; and a graphics processing unit that uses work color space-designating information, said information being associated with said graphics data and designating a work color space in a graphics processing device, to perform processing of said graphics data in a designated work color space.

According to the graphics processing device pertaining to the third aspect herein, graphics data can be processed using a color space in accordance with work color space-designating information associated with the graphics data. It is therefore a simple matter to process graphics data using an appropriate work color space, and thus improve the result of graphics processing.

In a graphics processing device pertaining to the third aspect herein, said graphics data may additionally be associated with graphics processing control data for designating graphics processing conditions in said graphics processing unit; and graphics processing by said graphics processing unit performed on the basis of said graphics processing control data. With this arrangement, graphics processing can be performed appropriately for individual sets of graphics data, under designated processing conditions in a designated work color space.

In a graphics processing device pertaining to the third aspect herein, in the event that said graphics processing unit is unable to use said work color space-designating information, processing of said graphics data may be performed using a predetermined color space. With this arrangement, in the event that work color space-designating information cannot be used, graphics processing can be performed in a predetermined color space.

In a graphics processing device pertaining to the third aspect herein, in the event that said graphics processing unit is unable to use said work color space-designating information, processing of said graphics data may be performed using the color space defining said acquired graphics data. With this arrangement, graphics processing can at a minimum be performed in the color space defining the graphics data.

The graphics processing device pertaining to the third aspect herein may further comprise a multitude of output graphics data generating mechanisms for generating, from said processed graphics data, output graphics data for transmission to an output device; an output graphics generating mechanism selection unit for selecting from among said multitude of output graphics data generating mechanisms a said output graphics data generating mechanism corresponding to said retrieved work color space; and a transmitting unit for transmitting to said output device output graphics data generated by said selected output graphics generating mechanism. With this arrangement, output graphics data can be generated using an output graphics generating mechanism appropriate for a particular work color space.

In a graphics processing device pertaining to the third aspect herein, said output graphics data generating mechanisms may use color conversion tables to convert said processed graphics data to said output graphics data. With this arrangement, color conversion from processed graphics data to output graphics data can be accomplished faster and more accurately.

The graphics processing device pertaining to the third aspect herein may further comprise an output graphics data generating unit for converting graphics data of predetermined color space to output graphics data of a color space used by an output device; and a color space conversion unit for converting the color space of said processed graphics data to said predetermined color space. With this arrangement, graphics data of a work color space can be converted to graphics data of a predetermined color space that can be handled by an output graphics data generating unit (output device driver), enabling output graphics data to be output with reference to various output devices. Thus, the graphics processing device can be made compatible with a variety of output devices.

In a graphics processing device pertaining to the third aspect herein, said graphics data may additionally be associated with graphics processing control data designating graphics processing conditions for said graphics processing unit; and graphics processing by said graphics processing unit performed on the basis of said graphics processing control data. With this arrangement, graphics processing can be performed appropriately for individual sets of graphics data, under designated processing conditions in a designated work color space.

The invention in a fourth aspect thereof provides a computer-readable medium containing a program for executing processing of graphics data. The computer-readable medium pertaining to the fourth aspect herein comprises a program command for acquiring graphics data; and a program command that uses work color space-designating information, said information being associated with said graphics data and designating a work color space in a graphics processing device, to execute processing of said graphics data in the designated work color space.

The computer-readable medium pertaining to the fourth aspect herein affords working effects similar to the graphics processing device pertaining to the third aspect herein. Like the graphics processing device pertaining to the third aspect herein, the computer-readable medium pertaining to the fourth aspect herein may be reduced to practice in various ways.

The invention in a fifth aspect thereof provides a graphics processing system including a graphics processing mechanism and an output data generating mechanism. In the graphics processing system pertaining to the fifth aspect herein

said graphics processing mechanism comprises a graphics data acquisition unit for acquiring graphics data; and a graphics processing unit that uses work color space-designating information, said information being associated with said graphics data and designating a work color space in a graphics processing device, to perform processing of said graphics data in a designated work color space;

and wherein said output data generating mechanism comprises a color conversion unit that uses a color conversion table to convert the color space of said processed graphics data to the reproducible color space of an output device; and a color conversion table modification unit for modifying, with reference to said work color space, the color conversion table used by said color conversion unit.

According to the graphics processing system pertaining to the fifth aspect herein, through cooperation of the graphics processing mechanism and output data generating mechanism, there are afforded working effects similar to the graphics processing device pertaining to the third aspect; and like the graphics processing device pertaining to the fifth aspect herein, may be reduced to practice in various ways.

The invention in a sixth aspect thereof provides a graphics processing system including a graphics processing mechanism and an output data generating mechanism. In the graphics processing system pertaining to the sixth aspect herein

said output graphics data generating mechanism comprises a color conversion unit for converting graphics data defined in a predetermined color space to graphics data defined in a color space reproducible by an output device; and

said graphics processing mechanism comprises a graphics data acquisition unit for acquiring graphics data; a graphics processing unit that uses work color space-designating information, said information being associated with said raphics data and designating a work color space in a graphics processing device, to process said graphics data in a designated work color space; and a space conversion unit for converting the color space of said processed graphics data to said predetermined color space.

According to the graphics processing system pertaining to the sixth aspect herein, through cooperation of the graphics processing mechanism and output data generating mechanism, there are afforded working effects similar to the graphics processing device pertaining to the third aspect; and like the graphics processing device pertaining to the sixth aspect herein, may be reduced to practice in various ways.

The invention in a seventh aspect thereof provides a graphics processing device. The graphics processing device pertaining to the seventh aspect herein comprises a first color conversion unit for converting the color space of acquired graphics data to a first RGB color space in accordance with work color space-designating information, said information being associated with said acquired graphics data and designating a work color space in a graphics processing device; a graphics processing unit for processing said graphics data in said first RGB color space; a color space information acquisition unit for acquiring information about an RGB color space used by an output graphics processing device that generates from said processed graphics data graphics data for output; and a second color conversion unit that, in the event that the RGB color space used by said output graphics processing device is a second RGB color space different from said first RGB color space, converts the color space of said processed graphics data from said first RGB color space to said second RGB color space on the basis of said acquired color space information.

The graphics processing device pertaining to the seventh aspect herein affords working effects similar to the graphics processing device pertaining to the third aspect herein.

In the graphics processing device pertaining to the seventh aspect herein, said acquired graphics data may be graphics data defined in a third RGB color space; and said graphics processing unit, in the event of being unable to use said work color space-designating information, may process said graphics data in said third RGB color space.

In the graphics processing device pertaining to the seventh aspect herein, said first RGB color space may have at least in a portion of the gamut thereof a color representation range wider than said third RGB color space. This enables graphics processing that preserves the saturation of the source graphics data, enabling output of highly saturated images.

The graphics processing device pertaining to an eighth aspect herein comprises a first color conversion unit for converting the color space of acquired graphics data to a YCbCr color space in accordance with work color space-designating information, said information being associated with said acquired graphics data and designating a work color space in a graphics processing device; a graphics processing unit for processing said graphics data in said first color space; a color space information acquisition unit for acquiring information about an RGB color space used by an output graphics processing device that generates from said processed graphics data graphics data for output; and a second color conversion unit for converting, on the basis of said acquired color space information, the color space of said processed graphics data from said YCbCr color space to an RGB color space used by said output graphics device.

The graphics processing device pertaining to a ninth aspect herein comprises a first color conversion unit for converting the color space of acquired graphics data to an RGB color space in accordance with work color space-designating information, said information being associated with said acquired graphics data and designating a work color space in a graphics processing device; a graphics processing unit for processing said graphics data in said RGB color space; a color space information acquisition unit for acquiring information about a YCC color space used by an output graphics processing device that generates from said processed graphics data graphics data for output; and a second color conversion unit for converting, on the basis of said acquired color space information, the color space of said processed graphics data from said RGB color space to said YCC color space.

The graphics processing device pertaining to a tenth aspect herein comprises a first color conversion unit for converting the color space of acquired graphics data to a first YCC color space in accordance with work color space-designating information, said information being associated with said acquired graphics data and designating a work color space in a graphics processing device; a graphics processing unit for processing said graphics data in said first YCC color space; a color space information acquisition unit for acquiring information about a YCC color space used by an output graphics processing device that generates from said processed graphics data graphics data for output; and a second color conversion unit that, in the event that the YCC color space used by said output graphics processing device is a second YCC color space different from said first YCC color space, converts the color space of said processed graphics data from said first YCC color space to said second YCC color space on the basis of said acquired color space information.

The graphics processing devices pertaining to the eighth to tenth aspects herein afford working effects similar to the graphics processing device pertaining to the seventh aspect herein. Like the graphics processing device pertaining to the seventh aspect herein, the graphics processing devices pertaining to the eighth to tenth aspects herein may be reduced to practice in various ways.

The invention in an eleventh aspect thereof provides a computer-readable medium containing a program for executing processing of graphics data. The computer-readable medium pertaining to the eleventh aspect herein comprises a program command for converting the color space of acquired graphics data to a first RGB color space in accordance with work color space-designating information, said information being associated with said acquired graphics data and designating a work color space in a graphics processing device; a program command for processing said graphics data in said first color space; a program command for acquiring information about an RGB color space used by an output graphics processing device that generates from said processed graphics data graphics data for output; and a program command that, in the event that the RGB color space used by said output graphics processing device is a second RGB color space different from said first RGB color space, converts the color space of said processed graphics data from said first RGB color space to said second RGB color space on the basis of said acquired information.

The computer-readable medium pertaining to the eleventh aspect herein affords working effects similar to the graphics processing device pertaining to the seventh aspect herein. Like the graphics processing device pertaining to the seventh aspect herein, the computer-readable medium pertaining to the eleventh aspect herein may be reduced to practice in various ways. The eighth to tenth aspects herein may similarly be reduced to practice as computer-readable media.

The various aspects of the invention may be reduced to practice by other methods or storage medium formats.

### BRIEF DESCRIPTION OF THE FIGURES

FIG. 1 is an illustrative diagram of an exemplary graphics processing system in which the graphics processing device pertaining to Embodiment 1 may be implemented.

FIG. 2 is an illustrative diagram showing the general internal structure of a graphics file GF stored in the Exif file format.

FIG. 3 is an illustrative diagram showing exemplary graphics processing control information GI parameters stored in Makernote.

FIG. 4 is a flow chart showing a main processing routine for graphics processing in personal computer 20 pertaining to Embodiment 1.

FIG. 5 is a flow chart showing the flow of graphics processing based on color space information in personal computer 20 pertaining to Embodiment 1.

FIG. 6 is a flow chart showing the flow of normal graphics processing in personal computer 20 pertaining to Embodiment 1.

FIG. 7 is a flow chart showing the flow of a print data generating process in personal computer 20 pertaining to Embodiment 1.

FIG. 8 is a flow chart showing the flow of graphics processing based on color space information in personal computer 20 pertaining to Embodiment 2.

FIG. 9 is a flow chart showing the flow of normal graphics processing in personal computer 20 pertaining to Embodiment 2.

FIG. 10 is a flow chart showing the flow of a print data generating process in personal computer 20 pertaining to Embodiment 2.

### DESCRIPTION OF THE PREFERRED EMBODIMENTS

A fuller understanding of the graphics processing device of the invention is provided through the following description of the embodiments, made with reference to the accompanying drawings.

A. Arrangement of graphics processing system including graphics processing device pertaining to Embodiment 1

B. Graphics processing in graphics processing device pertaining to Embodiment 1

C. Graphics processing in graphics processing device pertaining to Embodiment 2

D. Other embodiments

A. Arrangement of Graphics Processing System Including Graphics Processing Device Pertaining to Embodiment 1

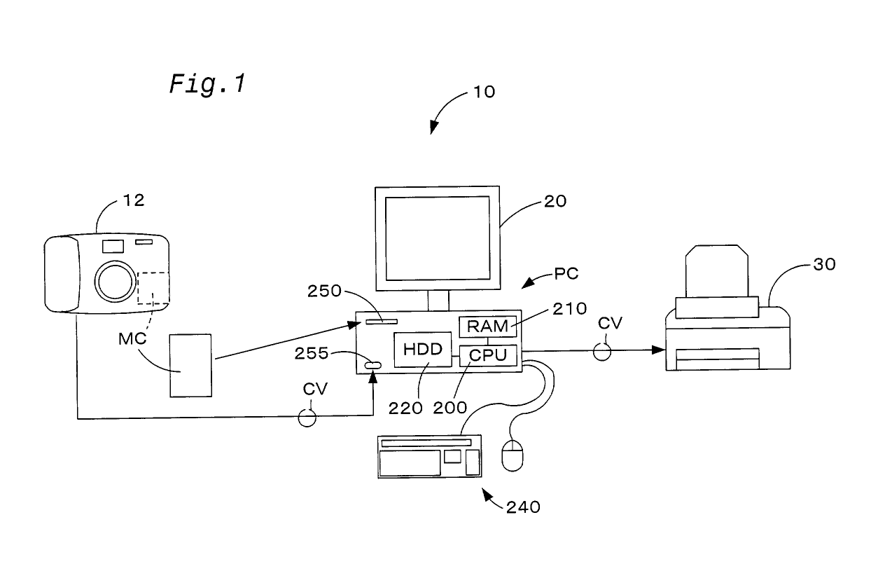

The following description of the arrangement of a graphics processing system in which a graphics processing device pertaining to a first embodiment may be implemented makes reference to FIG. 1. FIG. 1 is an illustrative diagram of an exemplary graphics processing system in which the graphics processing device pertaining to Embodiment 1 may be implemented.

Graphics processing system 10 comprises a digital still camera 12 serving as an input device for generating graphics data GD to which graphics processing conditions will be appended; a personal computer 20 serving as a graphics processing device that performs graphics processing, described later, using graphics data GD generated by digital still camera 12; and a color printer 30 serving as the graphics output device for personal computer 20. In the graphics processing device pertaining to this embodiment, graphics data GD (graphics file GF) for processing is input from digital still camera 12 to personal computer 20 via a connector cable CV or memory card MC.

Instead of a personal computer 20, the graphics processing device could also be, for example, a stand-alone printer having a graphics processing function. Instead of a printer 30, the output device could be a display device, e.g. a CRT or LCD display, a projector, or the like. In the following description, the output device is assumed to be a color printer 30 connected to a personal computer 20.

Personal computer 20 is a computer of the type used ordinarily, comprising a CPU 200 for executing the graphics processing program pertaining to the invention; RAM 210 for temporarily storing results of operations in CPU 200, graphics data, etc.; a hard disk drive (HDD) 220 storing the graphics processing program; a display device 230 for displaying results of operations in CPU 200, graphics data, etc.; and input devices, namely, a keyboard and mouse, for entering commands, numerical values etc. Personal computer 20 also has a memory slot 250 for inserting a memory card MC, and an I/O terminal 255 for connection to a connector cable CV from digital still camera 12 etc.

Digital still camera 12 converts optical information to an analog electrical signal by means of a CCD or photomultiplier, and converts the resultant analog electrical signal to a digital signal with an A/D converter to generate digital graphics data. Digital graphics data so generated is typically stored on a memory card MC serving as the storage device. The format for storing image data in digital still camera 12 is typically the JPEG format, but other storage formats could be employed, such as TIFF, GIF, BMP, or RAW data format.

The digital still camera 12 in accordance with the present embodiment generates a graphics file in which is embedded, for each set of graphics data GD, graphics processing control information GI consisting of work color space information that designates a work color space for performing graphics processing in a graphics processing device (computer, printer). Work color space may be selected arbitrarily via a liquid crystal screen etc. provided to digital still camera 12, or designated by default in digital still camera 12 to a predetermined work color space. The designated work color space is advantageously an RGB color space having a wider color representation range than the color space of graphics data GD, i.e., wider than the RGB color space of digital still camera 12. Digital still camera 12 may also select or generate graphics processing control information GI with reference to the designated work color space. In terms of achieving more appropriate graphics processing, it is desirable to optimize graphics processing control information GI for each work color space.

Graphics data GD generated by digital still camera 12 typically has a data structure in accordance with the format specified for digital still camera image files (Exif). The Exif file specification was developed by the Japan Electronics and Information Technology Industries Association (JEITA).

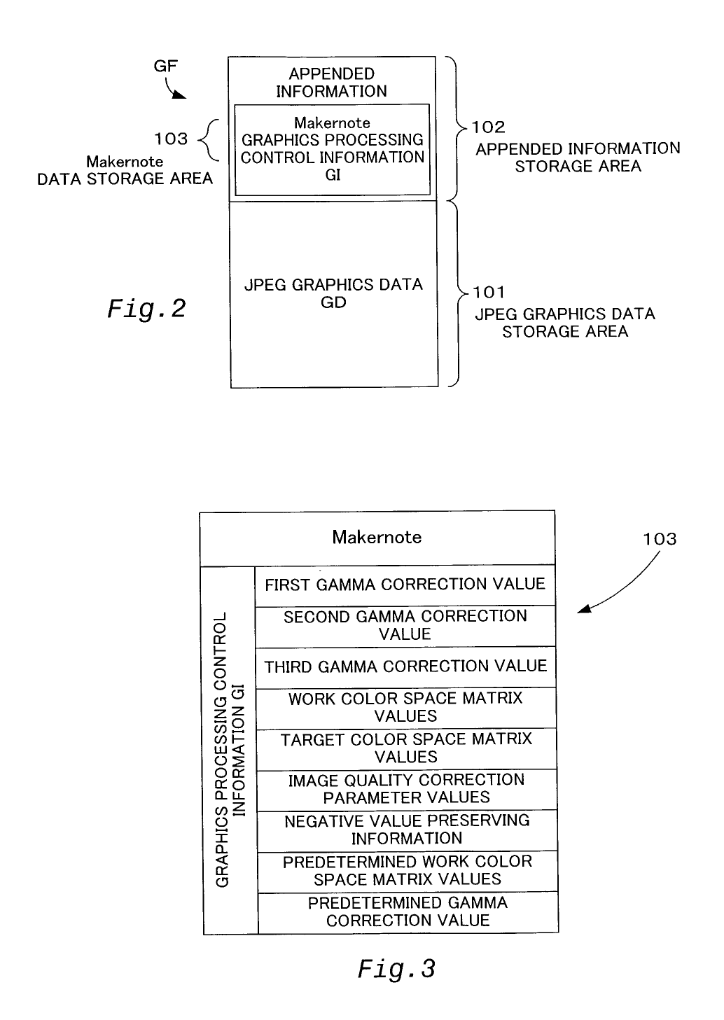

The following description of general structure in an image file having a file format in accordance with the Exif file format makes reference to FIGS. 2 and 3. FIG. 2 is an illustrative diagram showing the general internal structure of a graphics file GF stored in the Exif file format. FIG. 3 is an illustrative diagram showing exemplary graphics processing control information GI parameters stored in an extension information storage area. The terms “file structure”, “data structure” and “storage area” herein refer to files, data etc. stored in a memory device in file or data image form.

Graphics file GF, here, an Exif file, includes a JPEG image data storage area 101 containing graphics data GD in JPEG format; and an extension information storage area 102 containing appended information of various kinds relating to the stored JPEG graphics data GD. Appended information storage area 112 contains information relating to settings when the JPEG image was shot (e.g. color space at shooting, shooting date, exposure, shutter speed, etc.), and thumbnail image data for JPEG images stored in JPEG image data storage area 101. When graphics data GD is written to a memory card MC, this appended information is automatically stored in appended information storage area 102. In this embodiment, appended information storage area 102 also has a graphics processing control information storage area 103, shown in FIG. 3, for storing graphics processing control information GI used to control graphics processing of graphics data GD in personal computer 20.

Graphics processing control information GI may also be stored in a Makernote data storage area 103—this is an undefined area currently left available by DSC manufacturers—in appended information storage area 102.

Graphics processing control information GI contains information that, in consideration of the color reproduction characteristics and graphics output characteristics of an output device such as printer 30, indicates graphics output conditions that will give optimal graphics output result. Information contained by way of graphics processing control information GI may include, for example, work color space matrix values designating a work color space for graphics processing by personal computer 20; a second gamma correction value (work color space gamma correction value); target color space matrix values designating a target color space; a first gamma correction value (DSC gamma correction value); a third gamma correction value (printer color space gamma correction value); matrix values for a predetermined work color space; and a predetermined gamma correction value (gamma correction value for a predetermined work color space); as well as other parameters relating to image quality such as contrast, color balance adjustment, sharpness, and color correction.

Color printer 20 is capable of color image output, for example, an ink-jet printer that forms images by ejecting inks of four colors—for example, cyan (C), magenta (M), yellow (Y) and black (K)—onto a print medium to produce a dot pattern; or an electrophotographic printer that produces images by transferring and fixing color toner onto a print medium. Besides the four colors listed above, light cyan (LC), light magenta (LM), or dark yellow (DY) may also be used.

B. Graphics Processing in Graphics Processing Device Pertaining to Embodiment 1

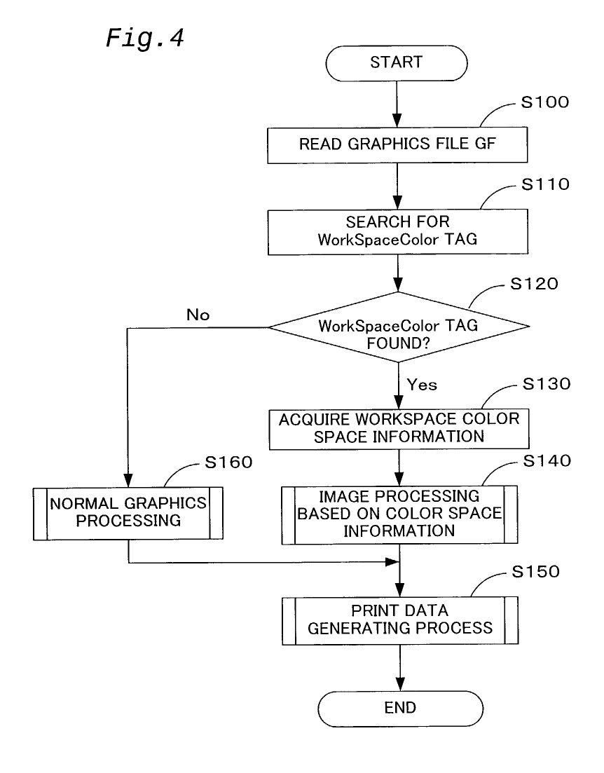

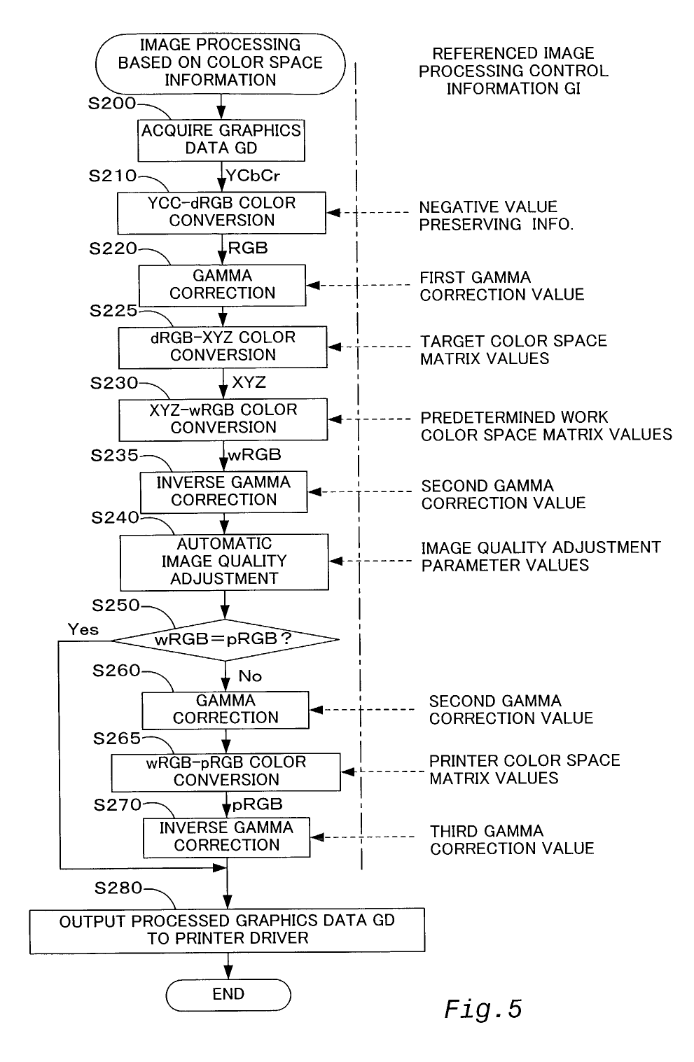

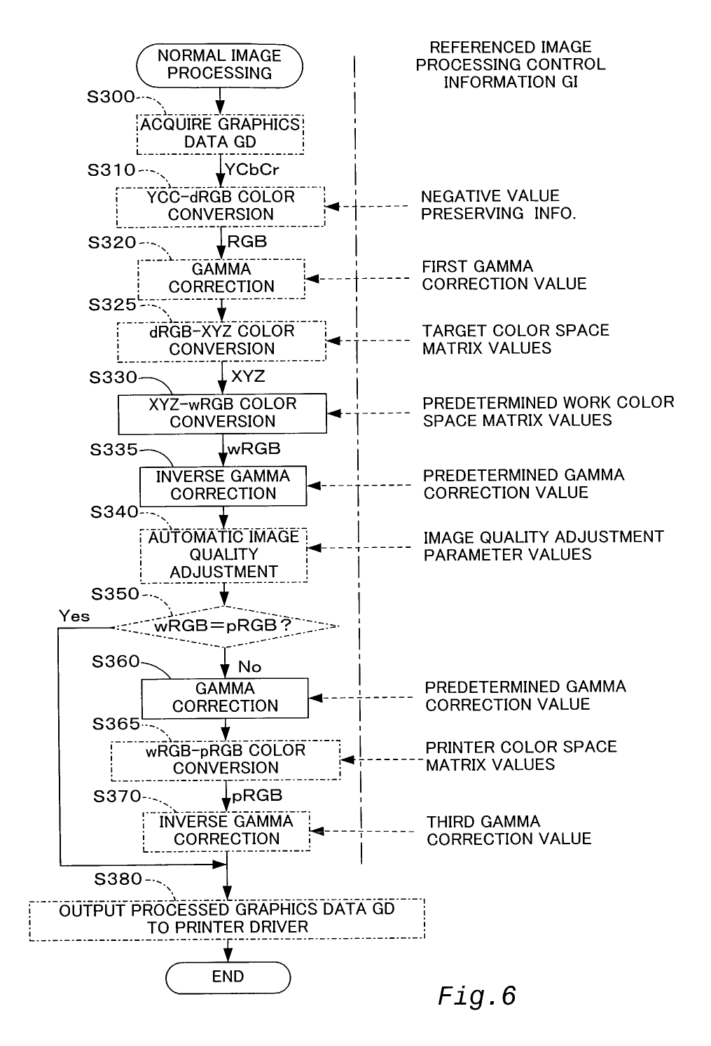

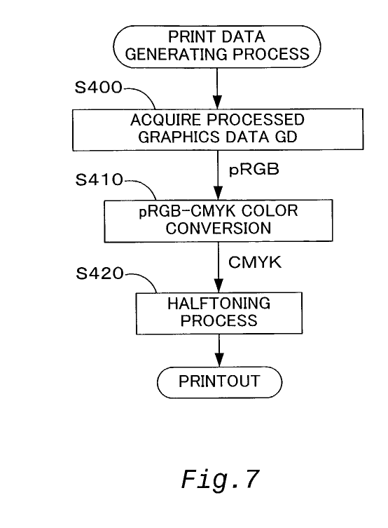

Graphics processing in personal computer 20 pertaining to Embodiment 1 is now described with reference to FIGS. 4-7. FIG. 4 is a flow chart showing a main processing routine for graphics processing in personal computer 20 pertaining to Embodiment 1. FIG. 5 is a flow chart showing the flow of graphics processing based on color space information in personal computer 20. FIG. 6 is a flow chart showing the flow of normal graphics processing in personal computer 20. FIG. 7 is a flow chart showing the flow of a print data generating process in personal computer 20.

When, for example, a memory card MC is inserted into slot 250, or the other end of a connector cable CV connected to DSC 12 is connected to I/O terminal 255, CPU 200 of personal computer 20 runs an application for executing the main processing routine. The following processes are executed in accordance with the processing steps of the application. CPU 200 reads the graphics file GF from memory card MC via slot 250 or connector cable CV, and temporarily places the read graphics file GF in RAM 210 (Step S100). CPU 200 acquires the graphics processing control information GI from the graphics file GF and searches for a WorkSpaceColor tag designating a work color space for graphics processing (Step S110). If CPU 200 successfully finds a WorkSpaceColor tag (Step S120: Yes) it acquires, from the designated work color space information, work color space matrix values and a second gamma correction value which is the gamma correction value for the designated work color space (Step S130). CPU 200 then executes graphics processing (described in detail hereinbelow) of graphics data GD contained in the graphics file GF, using the acquired work color space matrix values (Step S140). In addition to work color space matrix values, CPU 200 also acquires parameter values designating graphics processing conditions, including the parameter values given in FIG. 3. CPU 200 generates print data from the processed graphics data GD for output to printer 30 (Step S150) and terminates the main processing routine.

In the event that a WorkSpaceColor cannot be found, (Step S120: No), CPU 200 instead acquires from graphics processing control information GI predetermined work color space matrix values and a predetermined gamma correction value which is the gamma correction value for the predetermined work color space, and executes graphics processing of graphics data GD contained in the graphics file GF, using the predetermined work color space matrix values (Step S160). CPU 200 generates print data from the processed graphics data GD for output to printer 30 (Step S150) and terminates the main processing routine.

The following detailed description of graphics processing using designated work color space information makes reference to FIG. 7. CPU 200 acquires graphics data GD from the read out graphics file GF (Step S200). Digital still camera 12, as noted previously, stores graphics data GD as a file of JPEG format, and in a JPEG file, the color space of the generated graphics data GD (RGB color space) in converted to a YCbCr color space in order to increase compression. Accordingly, CPU 200 executes a YCC-dRGB color conversion process to convert the YCbCr graphics data GD to dRGB graphics data GD, dRGB being the color space used in DSC 12 (Step S210). In performing the color conversion, a matrix operation is performed using a matrix S, defined in the JPEG File Interchange Format (JFIF) specification.

When performing operations using matrix S, CPU 200, in accordance with negative value preserving information acquired as graphics processing control information GI, preserves negative data values (color values) included in the converted RGB graphics data GD and positive appended data values (color values) that lie outside the gamut of the particular RGB color space, or clips them to the gamut of the particular RGB color space. The particular RGB color space is, for example, the sRGB color space, which is commonly employed in standard operating systems (OS). Negative value preserving information may be handled as work color space-designating information. Where a color space having the same coordinate system as the graphics data GD color space serving as the work color space (sRGB, for example) is designated, by including information for preserving color values that are out of gamut with respect to the graphics data GD color space (i.e., negative color values and positive appended data values) during graphics processing, negative color values can be treated as valid values, at least during graphics processing, making it possible to prevent deterioration in image qualities (such as saturation).

To linearize the relationship with XYZ values, CPU 200 performs gamma correction of the resultant dRGB graphics data GD, using a first gamma correction value designated in the graphics processing control information GI (Step S220). CPU 200 applies matrix values of a target color space designated by graphics processing control information GI to matrix values making up a matrix M, to execute a dRGB-XYZ color conversion process (Step S225). Matrix M is a 3×3 matrix.

To perform graphics adjustment based on selected graphics adjustment parameters, CPU 200 executes a process to convert the color space of the graphics data GD from the XYZ color space to the wRGB color space designated as the work color space, i.e. an XYZ-wRGB color conversion process (Step S230). This color conversion is accomplished by an operation using an inverse matrix N⁻¹ that is the inverse of the 3×3 matrix N defining wRGB to XYZ color conversion. CPU 200 handles matrix values of the work color space designated by the graphics processing control information GI as matrix values of matrix N when performing the inverse matrix operation. CPU 200 performs inverse gamma correction using a second gamma correction value that is a gamma correction value for the work color space designated by the graphics processing control information GI (Step S235).

The dRGB graphics data is converted to wRGB graphics data by means of color conversion via the XYZ color space. For the purposes of description herein, matrix operations performed with matrix M and inverse matrix N⁻¹ are described as being independent operations, but in actual practice, a combined matrix could be generated from matrix M and inverse matrix N⁻¹, and dRGB-wRGB color conversion performed with this combined matrix MN⁻¹, to speed up operations.

The color space of the graphics data GD resulting from the inverse matrix N⁻¹ operation, namely, the work color space, is the wRGB color space. In preferred practice, this wRGB color space will have a gamut wider than the sRGB color space. Where the gamut of the wRGB color space is wider than the commonly used sRGB color space, negative color values and positive appended color values not included in the sRGB color space can be included in the gamut of the wRGB color space, allowing saturation not reproducible with the sRGB color space to be reproduced, so that the original high saturation of graphics data GD can be reproduced.

By using as the work color space an RGB color space whose gamut includes more color values, the results of subsequent graphics adjustment can be improved.

In order to characterize image qualities, CPU 200 now performs an automatic image quality adjustment process with the work color space wRGB designated by the graphics processing control information GI (Step S240). This process is performed using arbitrarily set image quality adjustment parameters included in the graphics processing control information GI. When performing automatic image quality adjustment, CPU 200 analyzes the characteristics of graphics data GD, and adjusts graphics data GD image quality adjustment parameters to reflect image quality adjustment parameters designated in the graphics processing control information GI, so as to reduce or eliminate differences between baseline values established for the parameters and values of parameters representing image qualities of graphics data GD. Image quality adjustment parameter values are used to modify baseline values, or change the extent (level) of reduction in differences between baseline values and image quality parameter values. Alternatively, they are used to directly modify image quality parameter values.

CPU 200 now determines whether the pRGB color space (the color space of printer 30) matches the wRGB color space (Step S250). Specifically, it determines whether the RGB-CMYK color conversion look-up table (LUT) used by the printer driver for printer 30 corresponds to the wRGB color space designated as the work color space. Since the RGB-CMYK color conversion LUT is stored on HDD 220 when the printer driver is installed on personal computer 20, CPU 200 can acquire device type information for printer 30 from the printer driver, and acquire the RGB-CMYK color conversion LUT characteristics.

If CPU 200 determines that the pRGB color space and wRGB color space do not match (Step S250: No), it performs a wRGB-pRGB color conversion process to convert wRGB graphics data to pRGB graphics data. First, to linearize the relationship with XYZ values, CPU 200 performs gamma correction of the graphics data GD using a second gamma correction value (Step S260). It then acquires the work color space matrix values from the graphics processing control information GI and the printer color space matrix values for printer 30 and performs wRGB-pRGB color conversion (Step S265). As with the dRGB-wRGB color conversion process described previously, this wRGB-pRGB color conversion process is performed via an XYZ color space, using a matrix M′ having the work color space matrix values and a matrix N′ having the printer color space matrix values. That is, wRGB data is converted to XYZ data by means of a matrix operation using matrix M′, and XYZ data is converted to pRGB data by means of a matrix operation using matrix N′.

CPU 200 performs inverse gamma correction using a third gamma correction value that is a gamma correction value for the printer color space from graphics processing control information GI (Step S270), outputs the graphics data GD converted to the pRGB color space to the printer driver (Step S280), and terminates the main routine.

If the pRGB color space and wRGB color space are determined to match (Step S250: Yes), the printer driver will be able to handle processed WRGB graphics data as-is, and so the If CPU 200 outputs the wRGB graphics data GD to the printer driver (Step S280), and terminates the main routine.

Referring now to FIG. 6, the details of normal graphics processing, performed when no work color space has been designated, is described. In the normal graphics processing shown in FIG. 6, processes identical to processes performed during graphics processing on the basis of work color space information described previously with reference to FIG. 5, namely, Steps 300-325, Step S340, Step S350, and Steps S365-S380, are identical to Steps S200-S225, Step S240, Step S250, and Steps S265-S280 described previously with reference to FIG. 5; in the drawing these are indicated by broken lines, and not described [where to do so would be redundant].

In Step S325, CPU 200, having performed the dRGB-XYZ color conversion process, performs a process to convert the graphics data GD color space from the XYZ color space to the wRGB color space, namely, an XYZ-wRGB color conversion process (Step S330). CPU 200 handles matrix values of a predetermined work color space, included in graphics processing control information GI, as matrix values of matrix N when performing the inverse matrix operation. CPU 200 performs inverse gamma correction using a predetermined gamma correction value that is a gamma correction value for the predetermined work color space included in graphics processing control information GI (Step S335).

CPU 200 then executes Step S340 and Step S350, and executes gamma correction using the predetermined gamma correction value to perform the wRGB-pRGB color conversion process (Step S360). It subsequently executes Steps S365-S380, outputs the processed pRGB color space graphics data GD to the printer driver, and terminates the main routine.

The following description of the print data generating process makes reference to FIG. 7. The process is typically realized as so-called printer driver function, and may be realized as a separate module from graphics processing, or a process integrated with graphics processing. CPU 200 acquires the processed graphics data GD (Step S400), and, referring to a pwRGB-CMYK conversion look-up table (LUT) stored on HDD 220, converts pRGB graphics data to CMYK graphics data (Step S410). That is, it converts graphics data GD consisting of R . G . B tone values to tone value data for the colors used by printer 30, for example, the six colors C . M . Y . K . LC . LM.

CPU 200 then performs a halftoning process on the CMYK graphics data (Step S420), sends the graphics data GD as raster data to the print control portion (not shown) of printer 30, executes print out, and terminates the main routine. An error diffusion method or systematic dithering method is typically used as the method for the halftoning process.

In this embodiment, all graphics data is performed in personal computer 20, but instead some or all graphics processing could be performed in printer 30. In this case an application for executing the graphics processing functions described with reference to FIG. 7 will be stored in a storage device (hard disk, ROM etc.) provided to the printer 30. The printer 30 is supplied with a graphics file GF, generated by digital still camera 12, via a cable CV or memory card MC. When printer 30 detects insertion of a memory card MC or insertion of a cable CV, the application may load automatically, whereby reading of the graphics file GF, analysis of graphics processing control information GI, and graphics data GD conversion and adjustment are performed automatically.

By means of graphics processing by personal computer 20 in accordance with Embodiment 1 described hereinabove, a work color space for performing graphics processing is established on the basis of graphics processing control information GI contained in the graphics file GF, enabling image quality adjustment processing to be performed on graphics data GD. Thus, graphics processing (image quality adjustment) may be done using an appropriate work color space for each set of graphics data GD. For example, by designating as the work color space an RGB color space having a wider gamut than the dRGB color space of the graphics data GD (the RGB color space used by digital still camera 12), data values (color values) that are out of gamut of the dRGB color space, and particularly negative data values (color values), can be handled as valid, to give printed results having higher saturation. That is, printed results having higher saturation can be obtained by using color information that cannot be reproduced in the dRGB color space due to being out of gamut.

By means of personal computer 20 pertaining to Embodiment 1, graphics data GD of the wRGB color space (the work color space) can be converted to the printer RGB color space (pRGB color space) corresponding to the RGB-CMYK color conversion LUT used by the printer driver. Thus, graphics data GD having been subjected to image quality adjustment in a designated work color space can be output correctly to a variety of printers 30. In other words, the graphics processing device of this embodiment device can be made compatible with a variety of printers.

By means of a digital still camera 12 in accordance with Embodiment 1, there can be generated a graphics file that contains graphics data GD and graphics processing control information GI that designates the color space of the work color space for performing graphics processing by personal computer 20. Accordingly, the work color space for use by personal computer 20 can be designated by means of digital still camera 12. By designating as the work color space a color space that includes in the gamut thereof all color values of the graphics data GD, output of graphics data GD to printer 30 without any loss of saturation is possible.

Designating a work color space in digital still camera 12 allows graphics processing (image quality adjustment) in personal computer 20 to be performed using the designated work color space, thereby obviating the need for the user to select work color space on personal computer 20, and affording high image quality obtained through designation of work color space in a simple manner.

C. Graphics Processing in Graphics Processing Device (Personal Computer 20) Pertaining to Embodiment 2

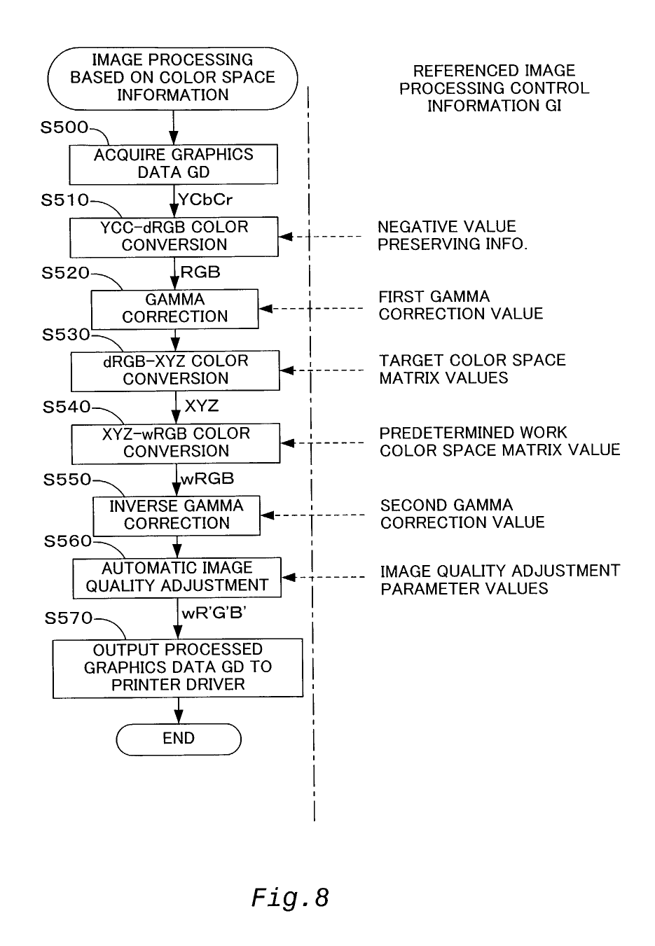

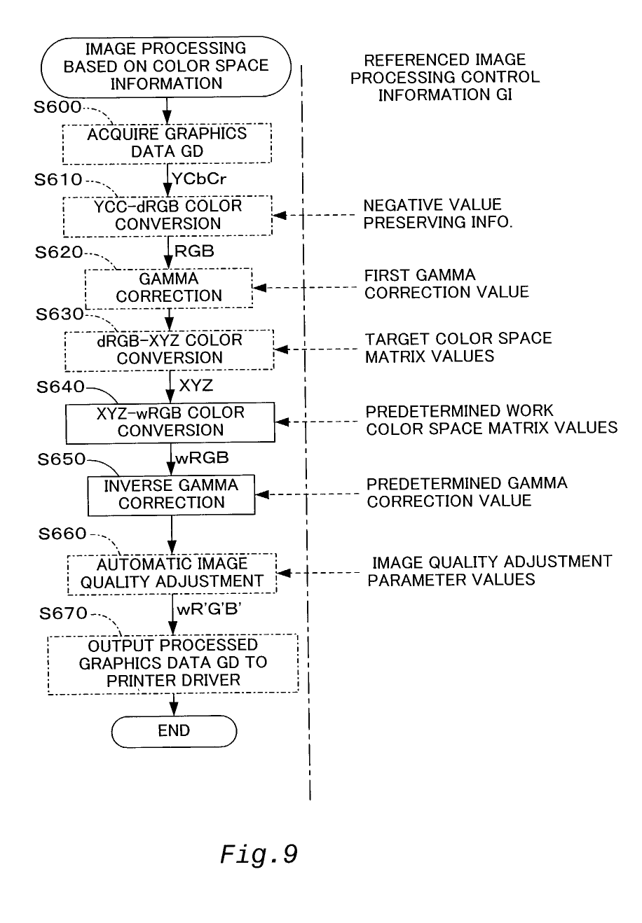

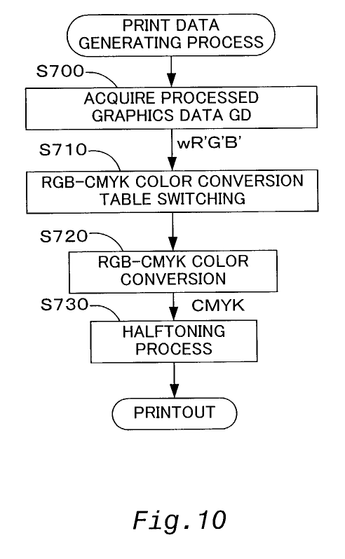

Graphics processing in personal computer 20 pertaining to Embodiment 2 is now described with reference to FIGS. 8-10. FIG. 8 is a flow chart showing the flow of graphics processing based on color space information in personal computer 20. FIG. 9 is a flow chart showing the flow of normal graphics processing in personal computer 20. FIG. 10 is a flow chart showing the flow of a print data generating process in personal computer 20. The main processing routine of graphics processing in personal computer 20 is similar to the processing routine described with reference to FIG. 4, and will not be described here.

The following detailed description of graphics processing using designated work color space information makes reference to FIG. 8. CPU 200 acquires graphics data GD from the read out graphics file GF (Step S500) and converts the YCbCr graphics data to dRGB graphics data, dRGB being the color space used in DSC 12 (Step S510). In performing the color conversion, a matrix operation is performed using a matrix S, defined in the JPEG File Interchange Format (JFIF) specification.

When performing operations using matrix S, CPU 200 refers to negative value preserving information acquired as graphics processing control information GI, and in accordance with this negative value preserving information performs clipping of the graphics data GD. CPU 200 performs gamma correction of the resultant dRGB graphics data GD, using a first gamma correction value designated by the graphics processing control information GI (Step S520), and applies matrix values of a target color space, also designated by graphics processing control information GI, to matrix values making up a matrix M, to execute a dRGB-XYZ color conversion process (Step S530).

To perform graphics adjustment based on selected image quality adjustment parameters, CPU 200 executes a process to convert the color space of the graphics data GD from the XYZ color space to the wRGB color space designated as the work color space, i.e. an XYZ-wRGB color conversion process (Step S540). CPU 200 then performs inverse gamma correction using a second gamma correction value that is a gamma correction value for the work color space designated by the graphics processing control information GI (Step S550).

The dRGB graphics data is converted to WRGB graphics data by means of color conversion via the XYZ color space. For the purposes of description herein, matrix operations performed with matrix M and inverse matrix N⁻¹ are described as being independent operations, but in actual practice, a combined matrix could be generated from matrix M and inverse matrix N⁻¹, and dRGB-wRGB color conversion performed with this combined matrix MN⁻¹, to speed up operations.

In order to characterize image qualities, CPU 200 now performs an automatic image quality adjustment process with the work color space wRGB designated by the graphics processing control information GI (Step S560). This process is performed using arbitrarily set image quality adjustment parameters included in the graphics processing control information GI. CPU 200 outputs the wRGB graphics data to the printer driver (Step S570), and terminates the main routine.

Referring now to FIG. 9, the details of normal graphics processing, performed when no work color space has been designated, is described. In the normal graphics processing shown in FIG. 9, processes identical to processes performed during graphics processing on the basis of work color space information described previously with reference to FIG. 8, namely, Steps 600-630, Step S660 and Step S670, are identical to Steps S500-S530, Step S560 and Step S570 described previously with reference to FIG. 8; in the drawing these are indicated by broken lines, and not described.

In Step S630, CPU 200, having performed the dRGB-XYZ color conversion process, performs a process to convert the graphics data GD color space from the XYZ color space to the wRGB color space, namely, an XYZ-wRGB color conversion process (Step S640). CPU 200 handles matrix values of a predetermined work color space, included in graphics processing control information GI, as matrix values of matrix N when performing the inverse matrix operation. CPU 200 performs inverse gamma correction using a predetermined gamma correction value that is a gamma correction value for the predetermined work color space included in graphics processing control information GI (Step S650).

CPU 200 then executes Step S660, outputs the processed wRGB color space graphics data GD to the printer driver (Step S670), and terminates the main routine.

The following description of the print data generating process makes reference to FIG. 10. The process is typically realized as so-called printer driver function. CPU 200 acquires the processed graphics data GD (Step S700), and switches the RGB-CMYK color conversion table to the RGB-CMYK color conversion table corresponding to the work color space RGB designated by the graphics processing control information GI (Step S710). Specifically, a multiplicity of RGB-CMYK conversion LUTs corresponding to a multiplicity of RGB color spaces have been stored on HDD 220 when the printer driver is installed on personal computer 20, for example; and CPU 200 selects the appropriate RGB-CMYK conversion LUT.

Referring to the switched RGB-CMYK conversion look-up table (LUT), CPU 200 converts RGB graphics data to CMYK graphics data (Step S720). That is, it converts graphics data GD consisting of R . G . B tone values to tone value data for the colors used by printer 30, for example, the six colors C . M . Y . K . LC . LM.

CPU 200 then performs a halftoning process (tone number conversion process) on the CMYK graphics data (Step S730), sends the graphics data GD as raster data to the print control portion (not shown) of printer 30, executes print out, and terminates the main routine. An error diffusion method or systematic dithering method is typically used as the method for the halftoning process.

By means of graphics processing by personal computer 20 in accordance with Embodiment 2 described hereinabove, a work color space for performing graphics processing is established on the basis of graphics processing control information GI contained in the graphics file GF, enabling image quality adjustment processing to be performed on graphics data GD. Thus, by designating as the work color space an RGB color space having a wider gamut than the dRGB color space of the graphics data GD (the RGB color space used by digital still camera 12), data values (color values) that are out of gamut of the dRGB color space, and particularly negative data values (color values), can be handled as valid, to give printed results having higher saturation. That is, printed results having higher saturation can be obtained by using color information that cannot be reproduced in the dRGB color space due to being out of gamut.

By means of the personal computer 20 pertaining to Embodiment 2, the RGB-CMYK color conversion LUT used by the printer driver can be switched to the corresponding RGB-CMYK conversion LUT with reference to the WRGB color space which the is work color space. This makes it possible to eliminate the color conversion process from the wRGB color space to the pRGB color space in personal computer 20, so that graphics processing speed can be increased.

D. Other Embodiments

During graphics processing in personal computer 20, in the event that no work color space is designated, of the automatic image quality adjustments, those image quality adjustments made using image quality adjustment parameters that directly modify image quality parameters can be performed subsequent to the YCC-RGB color conversion process. Since no work color space is designated, performing graphics processing (image quality adjustment) in the RGB color space of graphics data GD, i.e. the RGB color space of DSC 12 (dRGB) will result in the color values of the graphics data GD being preserved.

In each of the graphics processing embodiments described hereinabove, a color printer 30 is used as the output device; however, a CRT, LCD, projector or other display device could be used as the output device. In this case, depending on the display device used as the output device, a graphics processing program (display driver) for executing the graphics processing described with reference to FIG. 4 etc. could be run, for example. Or, where functioning as a CRT or other such computer display device, the graphics processing program could be run on the computer. In any case, the graphics data GD which is ultimately output will have an RGB color space, rather than a CMYK color space.

In this case, in a manner analogous to being able to output graphics data GD subjected to image quality adjustment in a selected work color space to a color printer 30, graphics data GD subjected to image quality adjustment in a selected work color space may be displayed on a CRT or other display device. Thus, by including parameters appropriate for a CRT or other display device in the graphics processing control information GI of a graphics file GF, or by including parameters optimized for the display characteristics of individual display devices, graphics data GD generated by a digital still camera 12 may be displayed more accurately.

The preceding embodiments describe generation of graphics files GF by a digital still camera 20, but graphics file GF could instead be generated with a digital video camera (DVC), scanner or other such input device (graphics file generating device). Where graphics files are generated by a digital video camera, these may be graphics files that contain still image data and output control information, or video files that contain video data and output control information, in MPEG or other format. Where video files are used, output control may be performed with reference to output control information for some or all of the video frames.

In the embodiments described hereinabove, the use of an RGB color space as the work color space is described, but instead a YCC color space could be used as the work color space. While RGB color space data (RGB data) is output to a color printer, YCC color space data (YCC data) could be output instead. In this case the personal computer 20 will be provided with an RGB-YCC color conversion function, and a YCC-CMYK color conversion function (e.g. LUTs).

The parameters given hereinabove are merely exemplary, and imply no limitation of the invention herein to these parameters. The matrices S, M, N⁻¹, M′ and N′⁻¹ given the Equations are likewise merely exemplary, and may be modified appropriately with reference to work color space, target color space, color space utilizable by color printer 30, etc.

While the preceding embodiments describe the use of a digital still camera 12 as the graphics file generating device, a scanner, digital video camera, or other device could be used instead Where a scanner is used, designation of graphics processing control information GI for graphics file GF may be performed on computer 20, or on the scanner independently, where the scanner is provided with a Preset button having settings information pre-assigned to it for setting information, or a Settings button and a display screen for making settings.

While Embodiment 1 describes an Exif format file as an exemplary graphics file GF, the graphics file format herein is not limited thereto. It is possible to use any graphics file that, at a minimum, includes graphics data GD for output by an output device, and information relating to a work color space for performing graphics processing (image quality adjustment) in an graphics processing device, such as a personal computer 20. The use of such files enables the original saturation of the graphics data GD to be reproduced by the output device.

Graphics files GF containing graphics data GD and graphics processing control information GI are herein considered to include files created by generating association data associating with graphics processing control information GI, storing the graphics data GD and graphics processing control information GI in separate files, but enabling the graphics data GD and graphics processing control information GI to be associated by referring to this association data during image processing. While in this case graphics data GD and graphics processing control information GI are stored in separate files, during image processing using the graphics processing control information GI, the graphics data GD and graphics processing control information GI are indivisibly united, so functionality is substantially the same as with storage in a single file. That is, the use of associated graphics data GD and graphics processing control information GI—at least during graphics processing—is included in the definition of graphics file GF herein. Video files stored on optical media such as CD-ROM, CD-R, DVD-ROM and DVD-RAM are also included.

While the graphics data generating device and graphics data output device pertaining to the invention have been shown and described with reference to certain preferred embodiments, the embodiments herein are intended to aid in understanding of the invention, and should not be construed as limiting thereof. It is intended that the present invention cover modifications and improvements provided they fall within the scope of the claims and their equivalents.

What is claimed is:

1. A graphics data generating device comprising:
a graphics data acquisition unit for acquiring graphics data;
a work color space-designating information acquisition unit for acquiring work color space-designating information that designates a work color space for graphics processing in a graphics processing device; and
an output unit for outputting said acquired graphics data associated with said work color space-designating information.

2. A graphics data generating device according to claim 1 further comprising:
a color conversion table-designating information generating unit for generating color conversion table-designating information that designates a color conversion table used to generate said output graphics data in an output processing control device that generates output graphics data using said graphics data.

3. A graphics data generating device according to claim 2 further comprising:
a graphics processing control data generating unit for designating graphics processing conditions in said graphics processing device with reference to said acquired work color space-designating information, wherein said output unit outputs said graphics data associated with said graphics processing control data as well as with said work color space-designating information.

4. A graphics data generating device according to claim 3, wherein said work color space has at least in a portion of the gamut thereof a color representation range wider than the sRGB color space.

5. A graphics data generating device according to claim 3 further comprising:
a graphics data generating unit for generating said graphics data; and
a memory unit for storing a multitude of sets of said work color space-designating information;
wherein said graphics data acquisition unit acquires said generated graphics data; and said work color space-designating information acquisition unit acquires said work color space-designating information from said memory unit.

6. A graphics data generating device according to claim 4 or 5, wherein said output unit outputs said graphics data and said work color space-designating information as a single graphics file.

7. A graphics data generating device according to claim 1, wherein said work color space-designating information designates a color space having a different coordinate system than the color space of said graphics data.

8. A computer-readable medium containing a program for generating graphics data, comprising:
a program command for generating graphics data;
a program command for acquiring space-designating information that designates a work color space for graphics processing in a graphics processing device used to process said graphics data; and
a program command for outputting said generated graphics data associated with said work color space-designating information.

9. A graphics processing device comprising:
a graphics data acquisition unit for acquiring graphics data; and
a graphics processing unit that uses work color space-designating information, said information being associated with said graphics data and designating a work color space in a graphics processing device, to perform processing of said graphics data in a designated work color space.

10. A graphics processing device according to claim 9, wherein said graphics data may additionally be associated with graphics processing control data for designating graphics processing conditions in said graphics processing unit;
wherein graphics processing by said graphics processing unit is performed on the basis of said graphics processing control data.

11. A graphics processing device according to claim 9 wherein
in the event that said graphics processing unit is unable to use said work color space-designating information, processing of said graphics data is performed using a predetermined color space.

12. A graphics processing device according to claim 9 wherein
in the event that said graphics processing unit is unable to use said work color space-designating information, processing of said graphics data is performed using the color space defining said acquired graphics data.

13. A graphics processing device according to claim 9 further comprising:
a multitude of output graphics data generating mechanisms for generating, from said processed graphics data, output graphics data for transmission to an output device;
an output graphics generating mechanism selection unit for selecting from among said multitude of output graphics data generating mechanisms a said output graphics data generating mechanism corresponding to said retrieved work color space; and
a transmitting unit for transmitting to said output device output graphics data generated by said selected output graphics generating mechanism.

14. A graphics processing device according to claim 13, wherein said output graphics data generating mechanisms use color conversion tables to convert said processed graphics data to said output graphics data.

15. A graphics processing device according to claim 9 further comprising:
an output graphics data generating unit for converting graphics data of predetermined color space to output graphics data of a color space used by an output device; and
a color space conversion unit for converting the color space of said processed graphics data to said predetermined color space.

16. A graphics processing device according to claim 14 or 15, wherein said graphics data is additionally associated with graphics processing control data designating graphics processing conditions for said graphics processing unit;
wherein graphics processing by said graphics processing unit is performed on the basis of said graphics processing control data.

17. A computer-readable medium containing a program for executing processing of graphics data, comprising:
a program command for acquiring graphics data; and
a program command that uses work color space-designating information, said information being associated with said graphics data and designating a work color space in a graphics processing device, to execute processing of said graphics data in the designated work color space.

18. A graphics processing system comprising a graphics processing mechanism and an output data generating mechanism,
wherein said graphics processing mechanism comprises:
a graphics data acquisition unit for acquiring graphics data; and
a graphics processing unit that uses work color space-designating information, said information being associated with said graphics data and designating a work color space in a graphics processing device, to perform processing of said graphics data in a designated work color space; and
wherein said output data generating mechanism comprises:
a color conversion unit that uses a color conversion table to convert the color space of said processed graphics data to the reproducible color space of an output device; and
a color conversion table modification unit for modifying, with reference to said work color space, the color conversion table used by said color conversion unit.

19. A graphics processing system comprising a graphics processing mechanism and an output data generating mechanism,
wherein said output graphics data generating mechanism comprises:
a color conversion unit for converting graphics data defined in a predetermined color space to graphics data defined in a color space reproducible by an output device; and
wherein said graphics processing mechanism comprises:
a graphics data acquisition unit for acquiring graphics data;
a graphics processing unit that uses work color space-designating information, said information being associated with said graphics data and designating a work color space in a graphics processing device, to process said graphics data in a designated work color space; and
a space conversion unit for converting the color space of said processed graphics data to said predetermined color space.

20. A graphics processing device comprising:
a first color conversion unit for converting the color space of acquired graphics data to a first RGB color space in accordance with work color space-designating information, said information being associated with said acquired graphics data and designating a work color space in a graphics processing device;
a graphics processing unit for processing said graphics data in said first RGB color space;
a color space information acquisition unit for acquiring information about an RGB color space used by an output graphics processing device that generates from said processed graphics data graphics data for output; and
a second color conversion unit that, in the event that the RGB color space used by said output graphics processing device is a second RGB color space different from said first RGB color space, converts the color space of said processed graphics data from said first RGB color space to said second RGB color space on the basis of said acquired color space information.

21. A graphics processing device according to claim 20, wherein
said acquired graphics data is graphics data defined in a third RGB color space; and
said graphics processing unit, in the event of being unable to use said work color space-designating information, processes said graphics data in said third RGB color space.

22. A graphics processing device according to claim 21 wherein said first RGB color space has at least in a portion of the gamut thereof a color representation range wider than said third RGB color space.

23. A graphics processing device comprising:
a first color conversion unit for converting the color space of acquired graphics data to a YCbCr color space in accordance with work color space-designating information, said information being associated with said acquired graphics data and designating a work color space in a graphics processing device;
a graphics processing unit for processing said graphics data in said YCbCr color space;
a color space information acquisition unit for acquiring information about an RGB color space used by an output graphics processing device that generates from said processed graphics data graphics data for output; and
a second color conversion unit for converting, on the basis of said acquired color space information, the color space of said processed graphics data from said YCbCr color space to an RGB color space used by said output graphics device.

24. A graphics processing device comprising:
a first color conversion unit for converting the color space of acquired graphics data to an RGB color space in accordance with work color space-designating information, said information being associated with said acquired graphics data and designating a work color space in a graphics processing device;
a graphics processing unit for processing said graphics data in said RGB color space;
a color space information acquisition unit for acquiring information about a YCC color space used by an output graphics processing device that generates from said processed graphics data graphics data for output; and
a second color conversion unit for converting, on the basis of said acquired color space information, the color space of said processed graphics data from said RGB color space to said YCC color space.

25. A graphics processing device comprising:
a first color conversion unit for converting the color space of acquired graphics data to a first YCC color space in accordance with work color space-designating information, said information being associated with said acquired graphics data and designating a work color space in a graphics processing device;
a graphics processing unit for processing said graphics data in said first YCC color space;
a color space information acquisition unit for acquiring information about a YCC color space used by an output graphics processing device that generates from said processed graphics data graphics data for output; and
a second color conversion unit that, in the event that the YCC color space used by said output graphics processing device is a second YCC color space different from said first YCC color space, converts the color space of said processed graphics data from said first YCC color space to said second YCC color space on the basis of said acquired color space information.

26. A computer-readable medium containing a program for executing processing of graphics data, comprising:
a program command for converting the color space of acquired graphics data to a first RGB color space in accordance with work color space-designating information, said information being associated with said acquired graphics data and designating a work color space in a graphics processing device;
a program command for processing said graphics data in said first color space;
a program command for acquiring information about an RGB color space used by an output graphics processing device that generates from said processed graphics data graphics data for output; and
a program command that, in the event that the RGB color space used by said output graphics processing device is a second RGB color space different from said first RGB color space, converts the color space of said processed graphics data from said first RGB color space to said second RGB color space on the basis of said acquired information.
